(19) United States
(12) Patent Application Publication
(10) Pub. No.: US 2004/0039927 A1
(43) Pub. Date: Feb. 26, 2004

(54) Semiconductor intergrated circuit, receiver apparatus using the same, receiver apparatus manufacturing method and repairing method, and video providing method

(76) Inventors: Katsuki Hazama, Tokyo (JP); Katsumi Kuwayama, Tokyo (JP)

Correspondence Address: SUGHRUE MION, PLLC, 2100 PENNSYLVANIA AVENUE, N.W., WASHINGTON, DC, 20037, US

(21) Appl. No.: 10/415,362

(22) PCT Filed: Oct. 23, 2001
(86) PCT No.: PCT/JP01/09279

(30) Foreign Application Priority Data
Oct. 30, 2000 (JP) 2000-331533

(51) Int. Cl. G06F 12/14

(52) U.S. Cl. 713/189

(57) ABSTRACT

A semiconductor integrated circuit in which a number of parts can be reduced in a receiver, etc. for reproducing an encrypted image signal and information can be written or over-written into a non-volatile memory after the hardware of the receiver is completed. The semiconductor integrated circuit for use in a device for receiving an encrypted image signal includes: an interface circuit for performing serial communication with an external; and a memory control circuit for controlling writing and/or reading of first information to be transmitted to the external by the interface circuit and second information to be used in decrypting the encrypted image signal to/from a non-volatile memory.

### TECHNICAL FIELD

The present invention relates generally to a semiconductor integrated circuit, and particularly to a semiconductor integrated circuit used in order to transmit or receive an encrypted image signal. Further, the present invention relates to a receiving-side device such as an image receiver employing a receiving semiconductor integrated circuit.

### BACKGROUND ART

The standard referred to as DDC (display data channel) relating to connecting a transmitting-side device such as a personal computer, etc. and a receiving-side device such as a monitor or projector, etc. is established in such a manner as to obtain the most appropriate signal for the receiving-side device from the transmitting-side device.

Image receivers conforming to the DDC standard have EEPROM (electrically erasable programmable read-only memory) storing information referred to as EDID (extended display identification data). The EDID includes information such as a type of image receiver, displayable resolution, clock frequency, manufacturer name, and serial no., etc. Further, a two-wire serial EEPROM is typically used as the EEPROM for storing the EDID, with data being exchanged using serial communication conforming to the I²C bus system (“I²C bus” is a registered trademark of Philips Semiconductors).

In this serial communication, control of and exchange of information with the EEPROM built-into the image receiver is carried out using two terminals referred to as an SDA (serial data) terminal and SCL (serial clock) terminal. When the SDA terminal and SCL terminal of the image receiver are connected to a personal computer via a cable, the personal computer can read out the EDID stored in the EEPROM. In this way, information relating to appropriate signals with regards to the image receiver is provided to the personal computer.

On the other hand, as an image signal transmitted from a personal computer, etc. to an image receiver, a digital signal becomes used rather than an analog signal, and therefore, there is almost no deterioration in the image signal. Consequently, it becomes necessary to provide protection to authors from illegal copying, etc. of image signals. As one means for achieving this, encryption of image signals transmitted from a personal computer, etc. to an image receiver has therefore been carried out. Here, a method referred to as HDCP (high-bandwidth digital content protection) is currently standard.

FIG. 1 is a block view showing an image transmission system using a related image receiver according to this HDCP method. As shown in FIG. 1, the image transmission system comprises a host computer 100 and an image receiver 200. Encryption key information (hereinafter also referred to as an “encryption key”) according to the HDCP method is held at the image receiver 200. The encryption key includes a “public key” of which the host computer 100 is notified by using DDC from the image receiver 200 and a “secret key” that should be kept secret from the unspecified general public.

The host computer 100 includes a graphics accelerator 11 for generating image signals for depicting images at high speed and an encryption LSI 10 according to the HDCP method. The encryption LSI 10 comprises a storage unit 12 for storing encryption keys, an HDCP encryption circuit 13 for encrypting image signals using keys stored in the storage unit 12, and a DVI transmitter interface circuit 14 for transmitting image signals. In the HDCP method, typically, a DVI (Digital Visual Interface) standard is used for the transmitting and receiving of image signals. Circuits for transmitting and receiving image signals therefore conform to the DVI standard.

On the other hand, the image receiver 200 comprises a serial EEPROM 221 for storing the EDID, and EEPROM 222 for storing encryption keys, a semiconductor integrated circuit (decrypting LSI) 230 for decrypting image signals, which have b en encrypted according to HDCP methods, using an encryption key, a liquid crystal panel 240, and a timing controller 241.

The decrypting LSI 230 comprises a master interface circuit 231 for controlling the EEPROM 222, a HDCP decrypting circuit 235, an interface circuit 236 for transmitting and receiving encryption keys, etc. and a DVI receiver interface circuit 237 for receiving image signals.

The liquid crystal panel 240 displays images based on the decrypted image signals. Further, the timing controller 241 controls the timing of inputting image signals into signal lines of the liquid crystal panel.

Moreover, the image receiver 200 has an SCL terminal 54 and SDA terminal 55 connected to the EEPROM 221 and the interface circuit 236, and an image signal terminal 56 connected to the DVI receiver interface circuit 237. Transmitting and receiving of signals to an external is then carried out via a DVI cable 50 connected to these terminals. The DVI cable 50 comprises an SCL signal line 51, an SDA signal line 52 and an image signal line 53 to be used in the sending and receiving of data according to the DDC standard.

When the system is activated, the host computer 100 can read out EDID stored in the EEPROM 221 of the image receiver 200 and the public keys stored in the EEPROM 222. At the host computer 100, the graphics accelerator 11 generates image signals appropriate for the image receiver 200 based on the received EDID. Further, when the image receiver 200 is authenticated based on the received public key, the HDCP encryption circuit 13 encrypts an image signal by using the encryption key, and the DVI transmitter interface circuit 14 transmits this to the image receiver 200.

At the image receiver 200, the master interface circuit 231 reads the encryption key from the EEPROM 222 and supplies this to the HDCP decryption circuit 235. The HDCP decrypting circuit 235 decrypts image signals received by the DVI receiver interface circuit 237 by using this encryption key. Based on the decrypted image signal, images are displayed at the liquid crystal panel 240 under control of the timing controller 241.

With this kind of image transmission system, as to the encryption key including a public key and a secret key stored in the EEPROM 222 of the image receiver 200, the secret key should remain unknown to the unspecified general public. It is therefore not possible to store in the same EEPROM the EDID that can be freely read out by using a personal computer, etc. and an encryption key that is limited to be read. For this reason, conventionally, only EDID is stored in the serial EEPROM 221 connected to a signal line for DDC use and the EEPROM 222 for storing the encryption key is prepared separately. The decrypting LSI 230 for decrypting the image signal controls the EEPROM 222 so as to read out the encryption key, and supplies only the public key to the DDC signal line in accordance with requests from a personal computer, etc.

The EEPROM 222 storing the encryption keys is a general purpose EEPROM although it is not connected to the SCL terminal 54 and the SDA terminal 55 constituting the DDC terminal, and therefore, the content of the EEPROM 222 can easily be read by using a ROM reader/writer, etc. Consequently, there is the fear that this content will be open to the general public in the case where the encryption key is stored as clear text in the EEPROM 222. A method has therefore been proposed of sealing between the EEPROM 222 and the decryption LSI 230 by using mold resin, etc. in order to prevent the encryption key from being read.

However, even if this method is adopted, it is still necessary to have two EEPROMs, one for storing EDID and the other for storing encryption keys. This means it is not possible to prevent an increase in costs accompanying this increase in parts. Further, because it is necessary to store the two types of information of the EDID and the encryption key individually in separate EEPROMs, in the process of manufacturing the receiver, the step for storing information and the testing step become complex, which proves expensive. In the case where the encryption key is written using clear text into an EEPROM and then sealing the EEPROM by using resin, etc. so that the encryption key cannot be read out, there is also the disadvantage that if there is a problem necessitating that the EEPROM be re-written, it is not possible to re-write the EEPROM.

### DISCLOSURE OF THE INVENTION

The present invention has been accomplished under these circumstances. It is a first object of the present invention to provide a semiconductor integrated circuit capable of reducing a number of parts used in a device on a receiving-side such as a receiver, etc. receiving an encrypted image signal, and to enable re-writing of information into a non-volatile memory after completion of the hardware. Further, it is a second object of the present invention to provide a semiconductor integrated circuit capable of improving security at a transmitting-side device for transmitting an image signal to a receiving-side device. Moreover, it is a third object of the present invention to provide a receiving-side device employing this kind of semiconductor integrated circuit for receiving signals.

In order to resolve the aforementioned problems, a semiconductor integrated circuit according to a first aspect of the present invention, for use in a device for receiving an encrypted image signal in accordance with DDC (display data channel) standard, comprises: a memory control circuit for controlling writing and/or reading of first information assigned to a receiving device according to the DDC standard and second information to be used in decrypting the encrypted image signal to/from a non-volatile memory; and an interface circuit for controlling transmitting and receiving of the first and second information so as to perform serial communication with an external.

A semiconductor integrated circuit according to a second aspect of the present invention, for use in a device for encrypting an image signal and transmitting the image signal to a receiving-side device, comprises: an image processing circuit for subjecting the image signal to predetermined image processing; a select circuit for selecting one of an image signal not subjected to the predetermined signal processing and an image signal subjected to the predetermined image processing; an encryption circuit for encrypting the image signal selected by the select circuit; and a control circuit for determining whether or not the receiving-side device is authentic on the basis of an encryption key received from the receiving-side device to control the select circuit and the encryption circuit such that the image signal not subjected to the predetermined signal processing is encrypted and output in the case where the receiving-side device is authenticated, and control the select circuit and the encryption circuit such that the image signal subjected to the predetermined processing is output without being encrypted in the case where the receiving-side device is not authenticated.

A semiconductor integrated circuit according to a third aspect of the present invention, for use in a device for encrypting an image signal and transmitting the image signal to a receiving-side device, comprises: an encryption circuit for encrypting an image signal; an image processing circuit for subjecting an image signal to predetermined image processing; a select circuit for selecting one of an encrypted image signal and an image signal subjected to the predetermined signal processing; and a control circuit for determining whether or not the receiving-side device is authentic on the basis of an encryption key received from the receiving-side device to control the select circuit such that the image signal not subjected to the predetermined signal processing is encrypted and output in the case where the receiving-side device is authenticated, and control the select circuit such that the image signal subjected to the predetermined processing is output without being encrypted in the case where the receiving-side device is not authenticated.

Further, a receiving-side device according to one aspect of the invention, for receiving an encrypted image signal in accordance with DDC (display data channel) standard, comprises: receiving means for receiving the encrypted image signal; a non-volatile memory for storing first information assigned to a receiving device according to the DDC standard and second information to be used in decrypting the encrypted image signal received by the receiving means; interface means for controlling transmitting and receiving of the first and second information so as to perform serial communication with an external; and decrypting means for decrypting the encrypted image signal received by the receiving means by using the second information stored in the non-volatile memory.

According to the present invention, EDID and encryption keys can be stored in a single non-volatile memory. Therefore, it is possible to reduce a number of parts used in the receiving-side device such as a receiver, etc., and the steps of writing information and carrying out tests in the process of manufacturing the receiving-side device can be simplified. Further, writing or over-writing of information into the non-volatile memory can be carried out after the hardware is completed. The manufacture of the receiving-side device is therefore straightforward and a receiving-side device can be repaired even if damage occurs after shipping.

Further, according to the present invention, it is determined whether or not the receiving-side device is authentic in the semiconductor integrated circuit for transmission so as to perform signal processing to degrade the image quality in the case where the receiving-side device is not authenticated. It is therefore possible to improve security without assistance of any external software.

### BRIEF DESCRIPTION OF THE DRAWINGS

Advantages and features of the present invention will become apparent when taken in conjunction with the following detailed description and the accompanying drawings. In these drawings, the same reference number represents identical constitutional elements.

FIG. 1 is a block view showing an image transmission system using a related image receiver.

FIG. 2 is a block view showing an image transmission system employing a receiver-side device according to a first embodiment of the present invention.

FIG. 3 is a block view showing an image transmission system employing a modified example of a receiver-side device according to the first embodiment of the present invention.

FIG. 4 is a flowchart showing an operation of writing an EDID into a non-volatile memory at a receiving-side device according to the first embodiment of the present invention.

FIG. 5 is a flowchart showing an operation of writing an encryption key into a non-volatile memory at a receiving-side device according to the first embodiment of the present invention.

FIG. 6 is a flowchart showing a method of providing images using a receiving-side device according to the first embodiment of the present invention.

FIG. 7 is a block view showing an image transmission system employing a receiver-side device according to a second embodiment of the present invention.

FIG. 8 is a flowchart showing a method of providing images using a receiving-side device according to the second embodiment of the present invention.

FIG. 9 is a block view showing an image transmission system employing a transmitting-side device according to a first embodiment of the present invention.

FIG. 10 is a block view showing an image transmission system employing a transmitting-side device according to a second embodiment of the present invention.

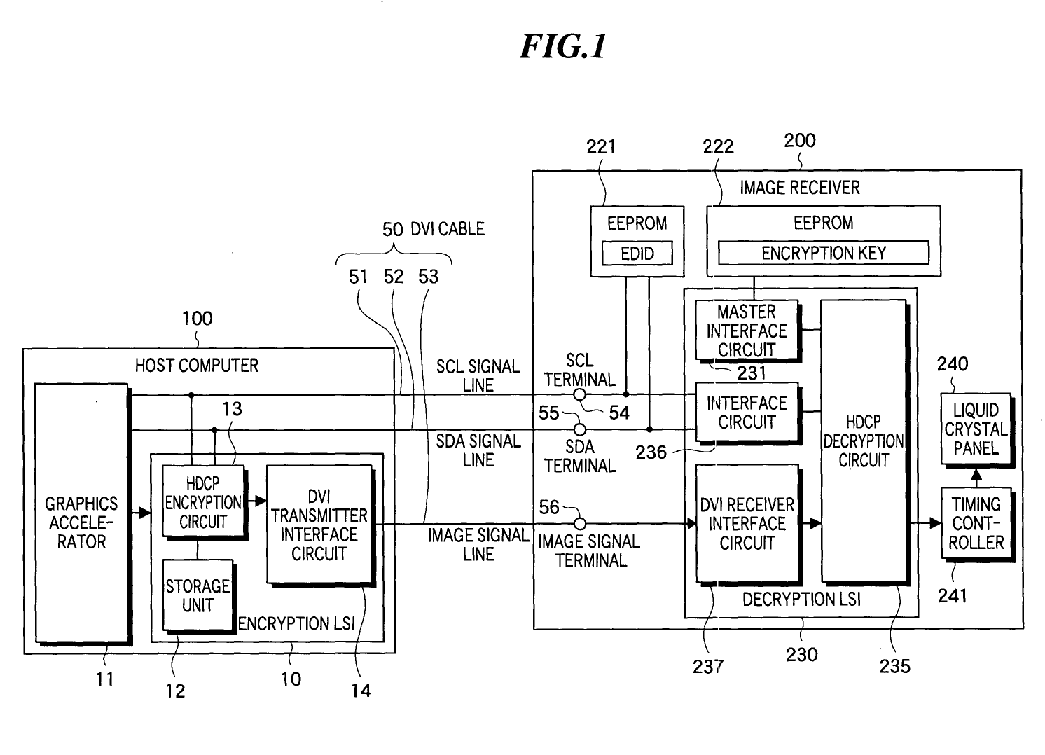

### BEST MODE FOR CARRYING OUT THE INVENTION

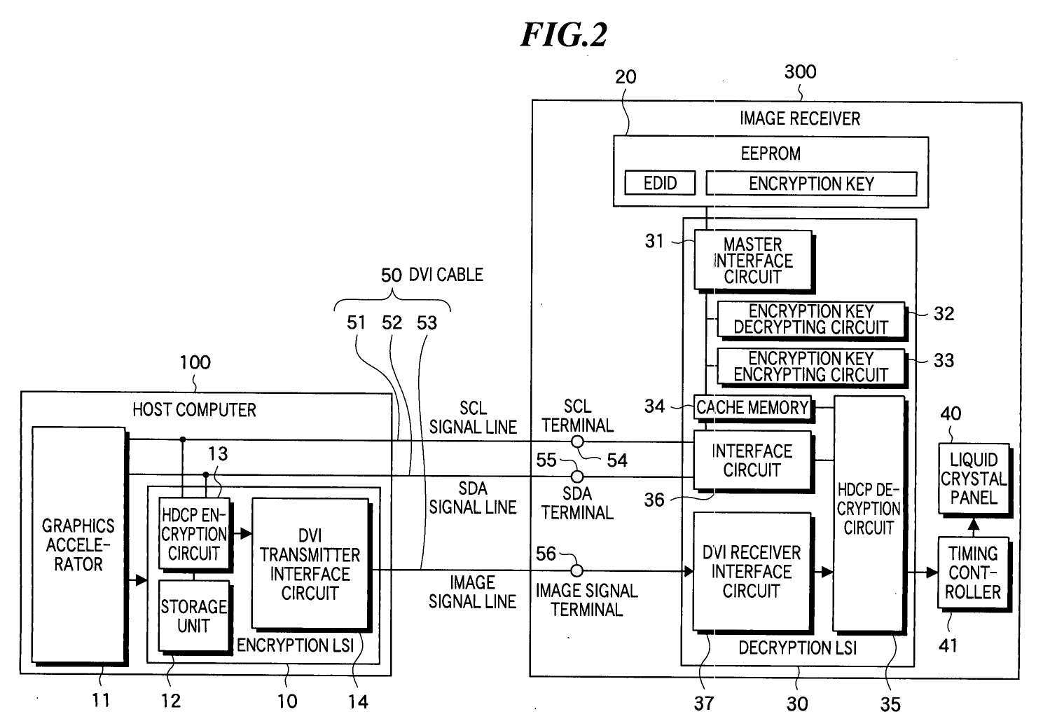

FIG. 2 is a block view showing an image transmission system employing a receiver-side device according to a first embodiment of the present invention. In the following embodiments, a description is given in the case where an image receiver having a display device such as a liquid crystal display device is employed as a receiving-side device, but the display device does not have to be included in the receiving-side device and it is also possible to connect an external display device to the receiving-side device.

As shown in FIG. 2, the image transmission system comprises a host computer 100 and an image receiver 300. The image receiver 300 holds an encryption key according to the HDCP method. The encryption key includes a public key of which a personal computer 100 is notified by using DDC from the image receiver 300 and a secret key that should remain unknown to the unspecified general public.

The host computer 100 includes a graphics accelerator 11 for generating an image signal for depicting images at high speed and an encryption LSI 10. The encryption LSI 10 comprises a storage unit 12 for storing the encryption key, an HDCP encryption circuit 13 for encrypting the image signal by using the encryption key stored in the storage unit 12, and a DVI transmitter interface circuit 14 for transmitting the image signal in accordance with the DVI specification.

The image receiver 300 is connected to the host computer 100 via a DVI cable 50 including an SCL signal line 51, an SDA signal line 52 and an image signal line 53.

The image receiver 300 comprises an EEPROM 20 taken as a non-volatile memory for storing EDID and an encryption key, a semiconductor integrated circuit (decryption LSI) 30 for decrypting an image signal encrypted in accordance with the HDCP method by using the encryption key, a liquid crystal panel 40 taken as a display device for displaying images based on the decrypted image signal, and a timing controller 41 for controlling the timing of inputting the image signal into the signal lines of the liquid crystal panel. As the non-volatile memory, general PROM or SRAM with a built-in battery can be used as well as a serial EEPROM, a parallel EEPROM or a flash EEPROM. Further, as the device for displaying images, a PDP (plasma display panel) or CRT (cathode ray tube) can be used as well as the liquid crystal panel 40.

The decryption LSI 30 includes therein a master interface circuit 31 for controlling the EEPROM 20, an encryption key decrypting circuit 32, an encryption key encrypting circuit 33, a cache memory 34, an interface circuit 36 for transmitting and receiving the encryption key, etc., an HDCP decryption circuit 35 for decrypting the image signal, and a DVI receiver interface circuit 37 for receiving the image signal. The decryption LSI 30 may also have a non-volatile memory such as the EEPROM 20, etc. built-in. Alternatively, the HDCP decoding circuit 35 and the DVI receiver interface circuit 37 may be formed in one semiconductor integrated circuit and the other circuitry may be formed in another separate semiconductor integrated circuit.

The interface circuit 36 controls transmission and reception of information such as EDID and the encryption key, etc. Further, the interface circuit 36 operates as a slave device when carrying out communication according to the I²C bus method. The interface circuit 36 is connected to the SCL terminal 54 and the SDL terminal 55, and carries out transmission and reception of signals to and from an external via the SCL signal line 51 and the SDA signal line 52.

The cache memory 34 temporarily saves information written into the EEPROM 20 and temporarily saves information read out from the EEPROM 20. As the cache memory 34, an SRAM (static random access memory) can be used.

The encryption key encryption circuit 33 encrypts the encryption key inputted by using clear text. The encrypted encryption key is saved in the EEPROM 20 by the master interface circuit 31. In the case where the encrypted encryption key is inputted to the decryption LSI 30, the encryption key encryption circuit 33 is not necessary.

The encryption key decryption circuit 32 decrypts the encrypted encryption key into clear text. The decrypted encryption key can then be used when the encrypted image signal is being decrypted.

The master interface circuit 31 controls transmission and reception of signals to and from the EEPROM 20 and writes and reads information to and from the EEPROM 20. The master interface circuit 31 has a mode of operation for comparing (verifying) information to be written into the EEPROM 20 and information already written into the EEPROM 20 so as to increase the reliability of the content written into the EEPROM 20. This operating mode can be set at the test mode of the decryption LSI 30.

When the encryption key is stored in an encryption manner in the EEPROM 20, the encryption key decryption circuit 32 decrypts the encrypted encryption key into clear text and the master interface circuit 31 compares the decrypted encryption key with the inputted key. The master interface circuit 31 may calculate an error detection code or an error correction code to verify information written into the EEPROM 20 in order to check whether or not information is correctly written into the EEPROM 20.

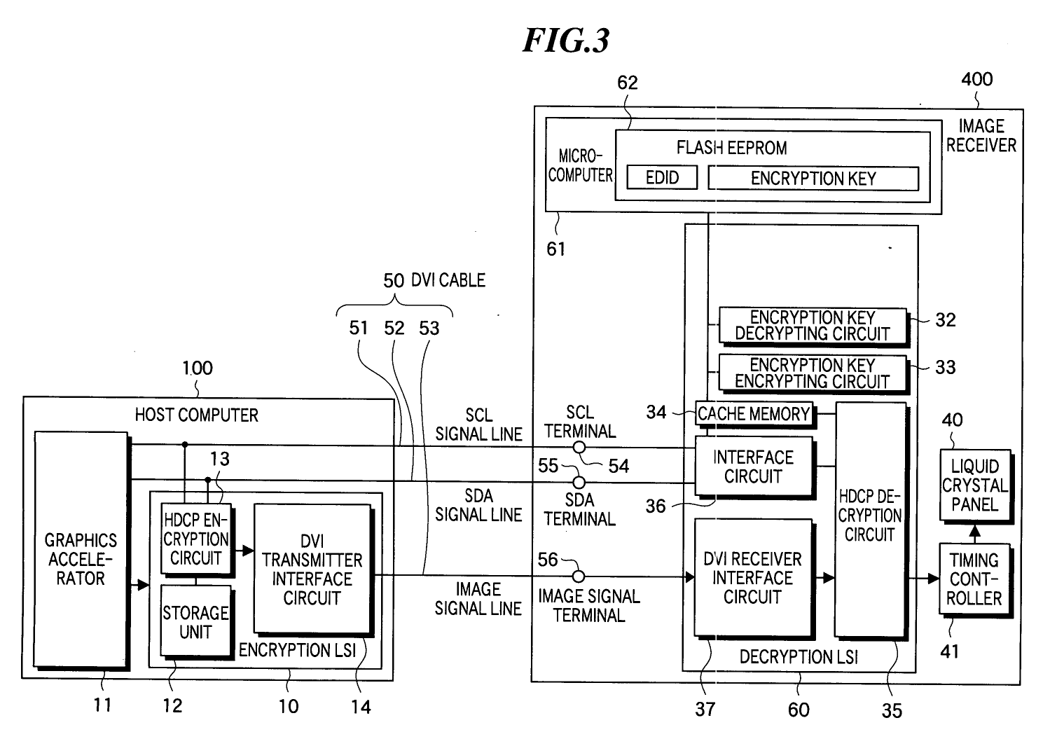

Alternatively, as shown in FIG. 3, it is also possible to use a microcomputer 61 with a flash EEPROM 62 built-in at the image receiver 400. The microcomputer 61 transmits and receives signals to and from the interface circuit 36 or the cache memory 34, and writes and reads information to and from the built-in EEPROM 62. In this case, the decryption LSI 60 does not need to have a master interface circuit built-in.

Referring again to FIG. 2, the HDCP decrypting circuit 35 decrypts the image signal received by the DVI receiver interface circuit 37 by using the encryption key according to the HDCP method.

The DVI receiver interface circuit 37 is connected to the image signal terminal 56 and receives a digital image signal via the image signal line 53. The DVI receiver interface circuit 37 conforms to the DVI standard and converts encoded and transmitted serial data into parallel data for all the three image signal channels of RGB (red, green, blue).

In the communication according to the I²C bus method, slave addresses are allotted to the respective slave devices. For example, typically, address “A0h” is allotted for reading and address “A1h” is allotted for writing in transmitting and receiving of EDID. Further, address “76h” is allotted for reading and address “77h” is allotted for writing at the receiver according to the HDCP method. The interface circuit 36 of this embodiment is designed so as to respond when slave address “A0h” and “A1h” allotted for EDID responses are specified as well as slave addresses “7Ah” and “7Bh” allotted for the receiver according to the HDCP method.

On the other hand, in the transmitter according to the HDCP method employed on the host side of the image receiver, addresses “78h” and “79h” are allotted for use in transmitting and receiving of the encryption key according to the HDCP method and other information, and address “70h” and “71h” are allotted for use in setting up the physical layer of the transmitter.

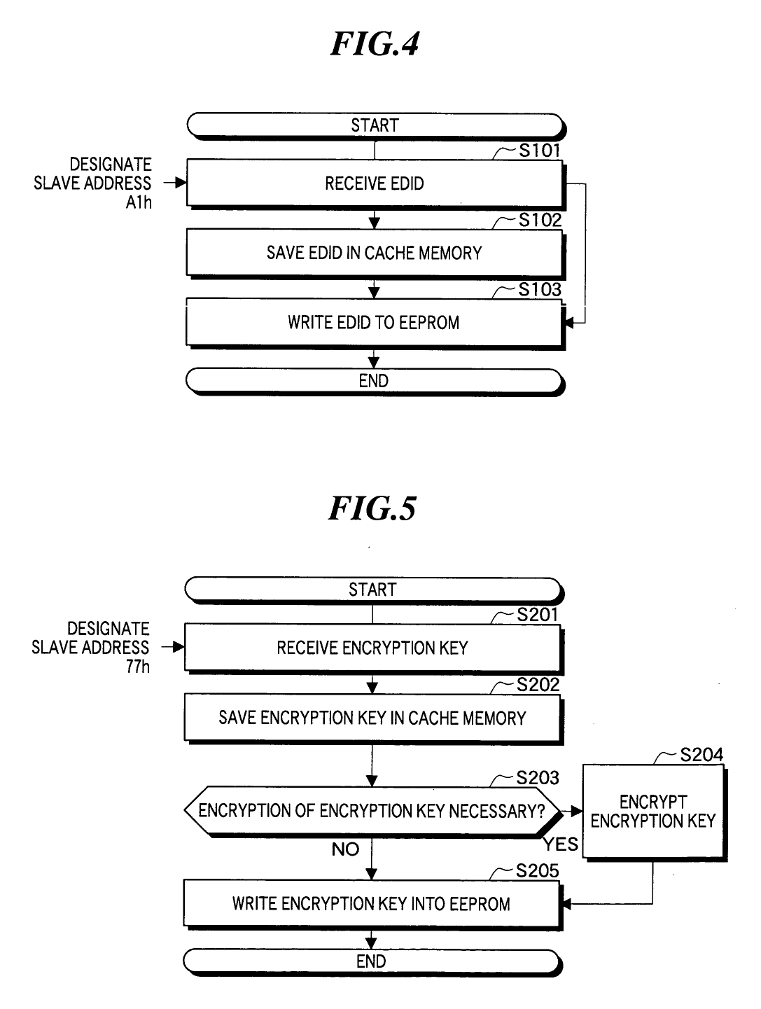

Next, referring to FIG. 2 and FIG. 4, a description is given about an operation of writing the EDID according to the DDC standard at the receiving-side device of this embodiment. In order to prevent erroneous operation in the EEPROM 20 storing the EDID, it is general to use a VSYNC signal (vertical synchronizing signal) constituting one of the image control signals. Also in this embodiment, control of writing and reading of the EDID additionally employs the VSYNC signal.

FIG. 4 is a flowchart showing an operation for writing the EDID into a non-volatile memory at a receiving-side device according to this embodiment. The writing operation is carried out after completion of the receiving-side device hardware.

At step S101, when the slave address A1h is designated by an external equipment such as the host computer 100, etc. and the EDID is transmitted, the decryption LSI 30 of the image receiver 300 receives the EDID by using the SCL terminal 54 and the SDA terminal 55.

At step S102, the interface circuit 36 temporarily saves the received EDID in the cache memory 34.

At step S103, the master interface circuit 31 writes the content held in the cache memory 34 into the EEPROM 20. Alternatively, the master interface circuit 31 may write the EDID into the EEPROM 20 in parallel while reading the EDID from the cache memory 34.

Next, referring to FIG. 2 and FIG. 5, a description in given about an operation of writing the encryption key according to the HDCP method at a receiving-side device of this embodiment.

FIG. 5 is a flowchart showing an operation of writing the encryption key according to the HDCP method into a non-volatile memory at a receiving-side device of this embodiment. The writing operation is also carried out after completion of the receiving-side device hardware.

At step S201, when the slave address 77h is designated by an external equipment such as the host computer 100, etc. and the encryption key is transmitted, the decryption LSI 30 of the image receiver 300 receives the encryption key by using the SCL terminal 54 and the SDA terminal 55.

At step S202, the interface circuit 36 temporarily saves the received encryption key in the cache memory 34.

At step S203, the decryption LSI 30 makes a determination as to whether or not it is necessary to encrypt the encryption key held in the cache memory 34. Because there is the fear of the encryption key being leaked when the encryption key is held as clear text in the EEPROM 20. It is therefore made possible to encrypt the encryption key for storage in the EEPROM 20 when the manufacturer of the image receiver wishes to keep the encryption key in a highly secure manner. The encryption key encrypting circuit 33 built into the decryption LSI 30 may be used for this encryption or a pre-encrypted encryption key may be transmitted to the decryption LSI 30.

When the encryption key is encrypted within the decryption LSI 30, the encryption key encrypting circuit 33 encrypts the encryption key at step S204 and then the transition to step S205 is made. Thus, the encryption key can be kept in an extremely secure manner at the image receiver by providing a mode for encrypting the encryption key.

The encryption strength same as or greater than the strength with which the image signal is encrypted is required for encrypting the encryption key. Further, a method that is difficult for general users to understand is then used as a method for making a transition to the encryption key encrypting mode, and the encryption algorithm can be kept secret by not making this method public. For example, when a special command is inputted to the decryption LSI 30, the encryption key encrypting circuit 33 may be activated and the transition is then made to the mode for encrypting the encryption key. It is also necessary for these kinds of special commands to keep security same as or greater than the strength with which the image signal is encrypted.

On the other hand, when an encryption key that is already encrypted is received or when an encryption key for which security is not so high is received so that it is considered acceptable for the encryption key to be held as clear text, a transition may be made directly to step S205. At step S205, the master interface circuit 31 writes the encryption key into the EEPROM 20.

The data format used while writing the EDID and the encryption key into the EEPROM 20 may differ from that set out in the DDC standard as far as the data format can be read by the decryption LSI 30. For example, a data format including error detection code or error correction code can also be used.

According to this embodiment, holding of the EDID and the encryption keys can be consolidated in a single EEPROM. Further, it becomes not necessary to fix mold between the EEPROM holding the encryption key and the decryption LSI 30 by encrypting the encryption key according to the HDCP method. In a process of manufacturing the image receiver, the writing of the EDID and the encryption key can be carried out after completion of the hardware by using the SCL terminal 54 and the SDA terminal 55. Also, when defects appear in the content of the EEPROM 20 after shipping of the image receiver, writing of the EDID and the encryption key can then be carried out in a repair operation.

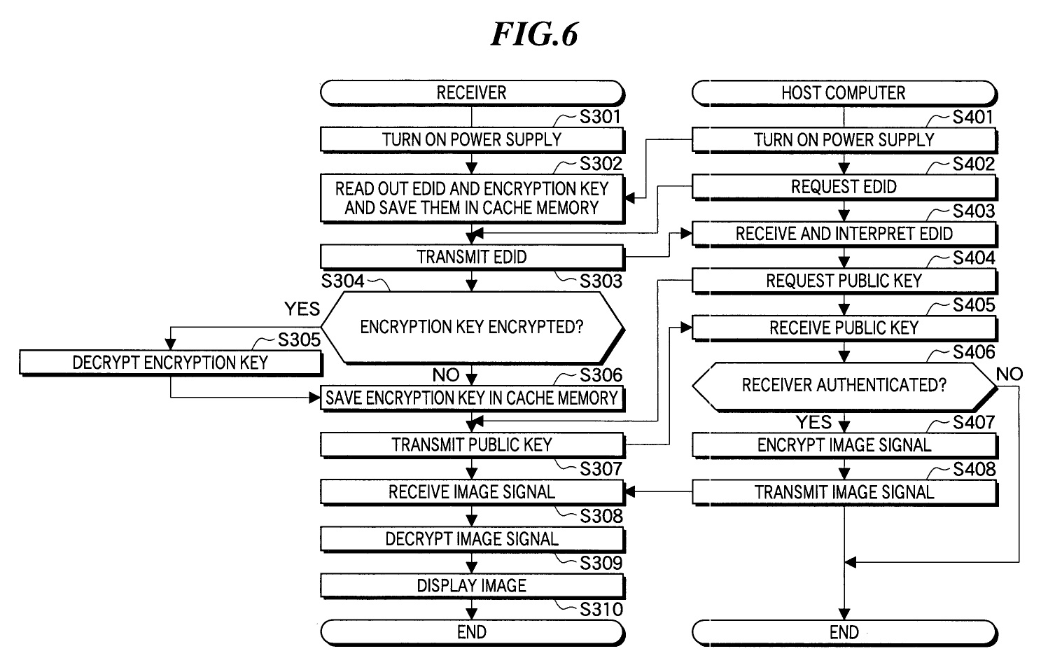

Next, referring to FIG. 2 and FIG. 6, description is given about a method of providing images using the receiving-side device of this embodiment. FIG. 6 is a flowchart showing a method of providing images using the receiving-side device according to this embodiment.

First, the power switch of the image receiver 300 is turned on at step S301, and the power switch of the host computer 100 is turned on at step S401.

When the power switch of the image receiver 300 is turned on, the image receiver 300 reads out the EDID and the encryption key written into the EEPROM 20 and holds them in the cache memory 34, and makes necessary preparation corresponding to a request from the host computer 100. This preparation operation is not limited to when the power switch is turned on and may also be carried out under control of the microcomputer, etc.

At step S402, the host computer 100 designates address A0h and A1h of the EDID via the SCL terminal 54 and the SDA terminal 55 and requests transmission of the EDID. In response to this, at step S303, the image receiver 300 utilizes the information held in the cache memory 34 and transmits the EDID to the host computer 100 via the interface circuit 36 while the decryption LSI 30 behaves as if it is an EEPROM only for the EDID. At step S403, the host computer 100 then receives the EDID and deciphers information relating to the image receiver 300.

Even if the power switch of the image receiver is not turned on, when there is a request for EDID transmission from the host computer 100, the decryption LSI 30 of the image receiver 300 should operate using the power supplied from the host computer 100 via the DVI cable so as to transmit the EDID. Typically, the host computer provides a supply voltage of 5V but the operating voltage of the decryption LSI is 3.3V, and therefore, a voltage-dropping circuit is required at the image receiver. Further, the current that can be used is 50 mA as standard, while this current is exceeded when the decryption LSI is operating at maximum capacity. It is therefore necessary to consider power consumption in order to transmit the EDID when the power switch of the image receiver is not turned on.

At step 304, the image receiver 300 determines whether or not an encryption key is encrypted. Namely, when the encryption key is read out from the EEPROM 20, the decryption LSI 30 of the image receiver 300 automatically recognizes whether or not the encryption key is encrypted. In the case where it is determined that the encryption key is encrypted, the encryption key decrypting circuit 32 decrypts the encryption key at step S305, and then, the decrypted encryption key is stored in the cache memory 34 at step S306. On the other hand, in the case where it is determined that the encryption key is not encrypted, the encryption key is stored as it is in the cache memory 34 at step S306.

When the host computer 100 employs the SCL terminal 54 and the SDA terminal 55 to request information such as the public key according to the HDCP method and so on at step S404, the image receiver 300 utilizes information stored in the cache memory 34 and transmits information such as the public key, etc. to the host computer 100 via the interface circuit 36 at step S307. Here, the interface circuit 36 does not transmit the HDCP method secret key as clear text to the host computer 100, and therefore, the risk of the HDCP method secret key being disclosed to the general public is lowered.

When a public key is received from the image receiver 300 at step S405, at the next step S406, the host computer 100 determines whether or not the image receiver 300 is authentic based on the public key. Specifically, the host computer 100 carries out calculations using random numbers and the secret key on the basis of the received public key and the host side public key and authenticates the image receiver 300 when the results of the calculation coincide.

When the image receiver 300 is authenticated, the host computer 100 encrypts the image signal at step S407 and then transmits the encrypted image signal to the image receiver 300 at step S408.

At step 308, the image receiver 300 receives the encrypted image signal. Namely, the DVI receiver interface circuit 37 receives a digital image signal for each channel of R, G and B transmitted as serial data via the image signal line 53 and converts this to parallel data. Next, at step S309, the HDCP decryption circuit 35 of the decryption LSI 30 decrypts the encrypted parallel data by using the encryption key according to the HDCP method stored in the cache memory 34.

At step S310, the decrypted digital image signal is output at the liquid crystal panel 40 via the timing controller 41 and the image is displayed.

In this embodiment, as an example of information to be used during transmission of the image signal, a description is given of the encryption key which is used in encrypting and decrypting the image signal. However, the information to be used during transmission and reception of the image signal is not limited to the encryption key but information which is used to set the image receiver in the most appropriate situation in order to display the transmitted and received image signal may also be useful. As this sort of information, setting information for image output timing, setting information for a PLL (Phase Locked Loop), information used for image size and color correction and so on may also be applicable.

Next, a receiving-side device according to a second embodiment of the present invention will be explained. The receiving-side device according to this embodiment is further provided with means for inputting information such as an encryption key, etc. from an external.

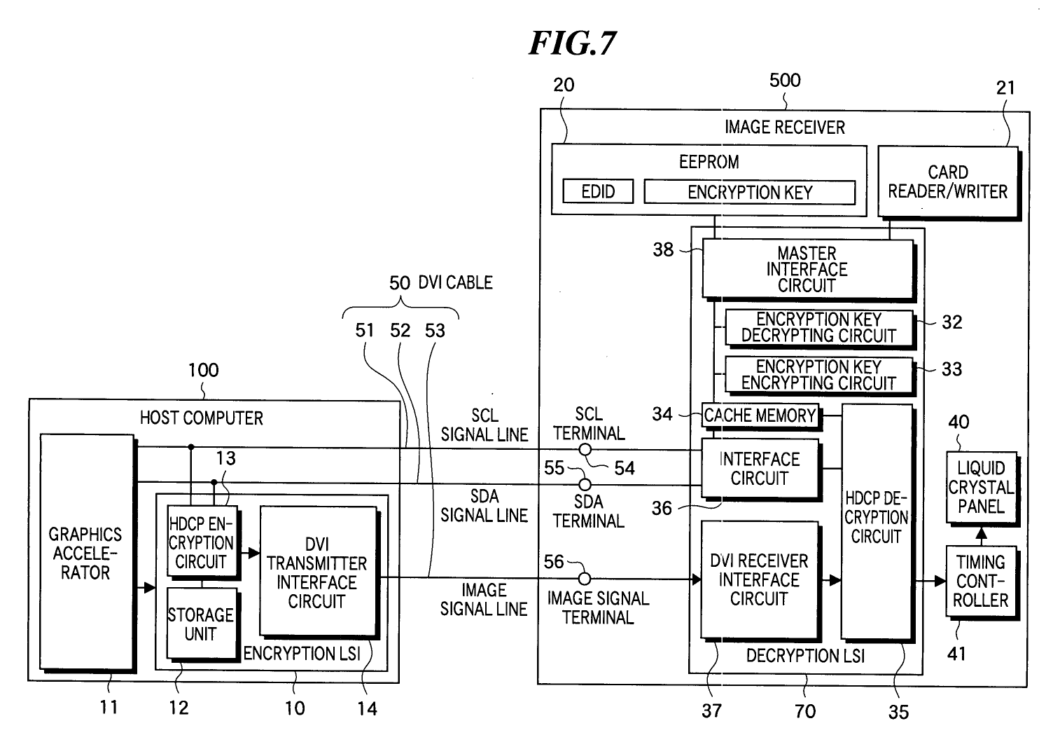

FIG. 7 is a block view showing an image transmission system employing a receiver-side device according to the second embodiment of the present invention. A card reader/writer 21 capable of reading from and writing to an IC card is provided at the image receiver 500 as means for inputting information such as the encryption key from the external. When an IC card recorded with a predetermined encryption key is inserted, the master interface circuit 38 of the decryption LSI 70 causes the encryption key read out by the card reader/writer 21 with priority over the EEPROM 20, to be stored in the cache memory 34. Other configuration of this embodiment is the same as for the receiving-side device of the first embodiment of the present invention.

As means for inputting information such as the encryption key, etc. from the external, an infrared light detection unit for reading information from a signal sent from an infrared remote control unit may also be provided in place of the card reader/writer 21. In this case, a viewer can input information such as the encryption key, etc. into the image receiver by operating the remote control unit for the image receiver.

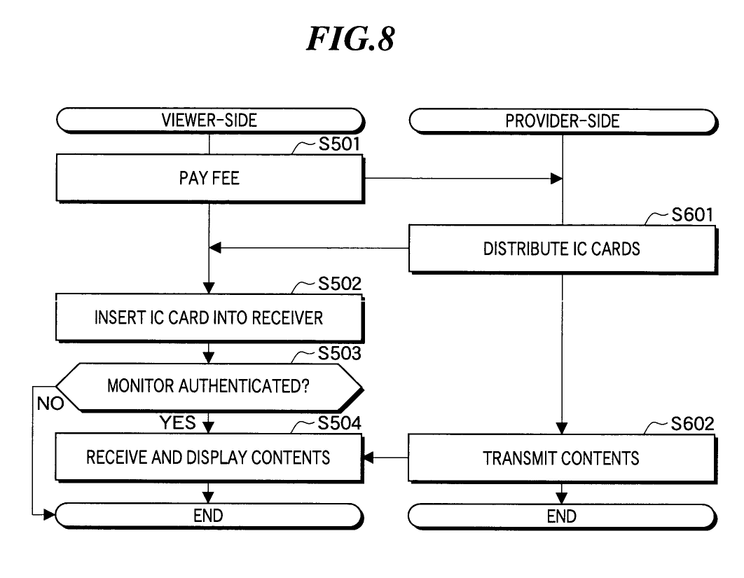

Next, referring to FIG. 7 and FIG. 8, a method of providing images using the receiving-side device of this embodiment will be explained. According to this image providing method, it is possible to output an image only on a monitor of a plurality of monitors (image receivers) connected to a set-top-box, etc. having the same function as the host computer which monitor is provided with a specific encryption key.

FIG. 8 is a flowchart showing a method of providing images using a receiving-side device according to this embodiment.

First, at step S501, the viewer pays or promises to pay a fee for a desired content such as image information to the provider of the content. In response to this, at step S601, the provider distributes an IC card written with a public key to each viewer. Further, at step S602, the provider sends the content for this sort of viewers.

When the viewer inputs the IC card into the monitor at step S502, at the next step S503 the set-top-box reads the public key written into the IC card and determines whether or not the monitor is authentic on the basis of the public key. When the monitor is authenticated, at step S504 the transmitted content is received by the monitor and is displayed on the monitor screen. The details of the operation occurring at step S503 and step S504 are the same as the operation at step S302 to step S310 and step S402 to step S408 in FIG. 6. According to the image providing method, only viewers that have paid for the content can receive this provided content.

In this image processing method, an IC card is used as the medium for inputting the public key, but the viewer may also send the public key to the monitor by using numeric key pads provided on a remote controller for the image receiver or may input the public key to the monitor by using a control unit for a game machine and OSD (open software description). Also, the content provider or the viewer may distribute the public key using a telephone line.

Next, a transmitting-side device according to a first embodiment of the present invention will be explained. Up until now, it has been assumed that the HDCP technology is used with personal computers. In order to encrypt and transmit an image signal by using a personal computer, it is necessary to communicate the public key between the DVI transmitter interface circuit of the personal computer and the DVI receiver interface circuit of the monitor and to determine whether or not the monitor is authentic. After this, the personal computer starts to encrypt the image signal and the monitor starts to decrypt the image signal. This series of control method is referred to as down streaming in the HDCP method.

The personal computer needs to encrypt an image signal only when reproducing a DVD disc, etc., but not when software such as a word processor software or a spreadsheet software is operating. Further, when the monitor is not an HDCP method-compatible monitor, it is necessary to carry out processing to indicate that the DVD disc cannot be played back or to indicate that picture quality is lowered during playback. In this control operation, the operation software and the HDCP control circuit built-into the graphics accelerator operate in cooperation with each other and this is referred to as up streaming in the HDCP method.

In the related transmitting-side device, as explained above, it is not possible to perform image signal transmission control with just the transmitting-side encryption LSI and the receiving-side decryption LSI and the assistance of software at an external is required, which raises problems with regards to security. The transmitting-side device according to this embodiment resolves these problems.

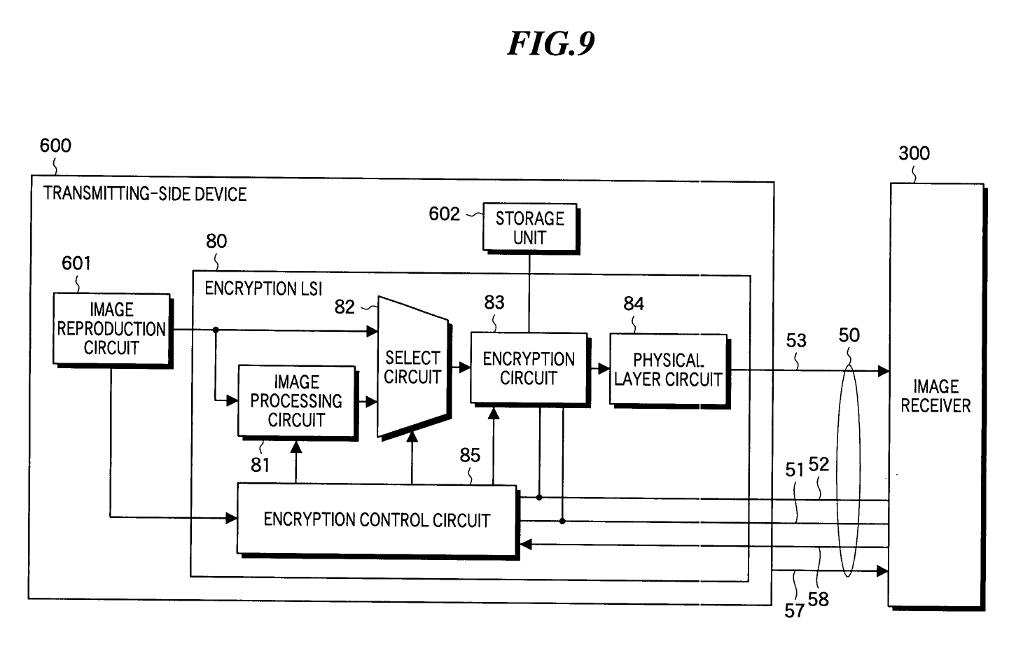

FIG. 9 is a block view showing an image transmission system employing a transmitting-side device according to a first embodiment of the present invention. The receiving-side device is the same as the image receiver 300 as shown in FIG. 2. The transmitting-side device 600 comprises an image signal reproduction circuit 601 for reproducing an image signal from a DVD disc, etc., a storage unit 602 for storing an encryption key, and an encryption LSI 80 for encrypting the image signal reproduced by the image signal playback circuit 601 by using the encryption key stored in the storage unit 602 and transmitting the encrypted image signal to the image receiver 300.

An encryption LSI 80 has an image processing circuit 81 for subjecting an image signal to predetermined image processing, a select circuit 82 for selecting one of an image signal output from the image signal reproduction circuit 601 and an image signal output from the image processing circuit 81, an encryption circuit 83 for encrypting the image signal selected by the select circuit 82, a physical layer circuit 84 for transmitting the image signal encrypted by the encryption circuit 83, and an encryption control circuit 85.

The encryption control circuit 85 determines whether or not the receiving-side device is authentic based on the received encryption key. When the receiving-side device is authenticated, the select circuit 82 and the encryption circuit 83 are controlled such that the image signal not subjected to the predetermined signal processing is encrypted and outputted. When the receiving-side device is not authenticated, the select circuit 82 and the encryption circuit 83 are controlled such that the image signal subjected to the predetermined processing is outputted without being encrypted.

The following is a detailed description of the operation of the receiving-side device according to this embodiment.

When the power switch of the transmitting-side device 600 is turned on, the encryption control circuit 85 supplies power to a part of the circuits of the image receiver 300 via a power supply line 57 included in a DVI cable 50, and reads the EDID from the EEPROM of the image receiver 300. In this way, the most appropriate image signal for the image receiver 300 can be known. When the EDID cannot be read, or when it is determined that the image receiver is not compatible with the HDCP method even if the EDID can be read, the encryption control circuit 85 makes a determination that the content that requires authentication cannot be transmitted.

When it is determined that the image receiver 300 is compatible with the HDCP method, the encryption control circuit 85 controls the encryption circuit 83 and the HDCP decryption circuit of the image receiver 300 to start authentication of the image receiver in accordance with the HDCP method. Specifically, the encryption control circuit 85 carries out calculations using random numbers and the secret key based on the received public key and the host side public key, and authenticates the image receiver when the results of the calculations coincide.

When the image receiver is authenticated, the encryption control circuit 85 controls the select circuit 82 to select an image signal output from the image signal reproduction circuit 601, and controls the encryption circuit 83 to start encryption of the image signal. The encryption control circuit 85 may detect whether or not the power switch is turned on at the image receiver 300 by using the hot-plug signal line 58 so as not to transmit the image signal until the power switch is turned on at the image receiver 300.

On the other hand, in the case where authentication of the image receiver is not finished within a predetermined time, the encryption control circuit 85 activates the image processing circuit 81, and controls the select circuit 82 to select an image signal output from the image processing circuit 81 and controls the encryption circuit 83 to output the image signal as clear text. The image processing circuit 81 implements processing to lower the resolution of the input image signal, implements processing to mix noise with the input image signal or outputs an image signal representing comments expressing that content cannot be transmitted, in place of the input image signal. In this way, in the case where the receiving-side device is not authenticated, it is possible to display a low-resolution image that does not require protection or comments expressing that content cannot be transmitted on the screen of the image receiver 300.

Next, a transmitting-side device according to a second embodiment of the present invention will be explained. In this embodiment, the select circuit is placed at a later stage than the encryption circuit, which is a difference point from the device as shown in FIG. 9.

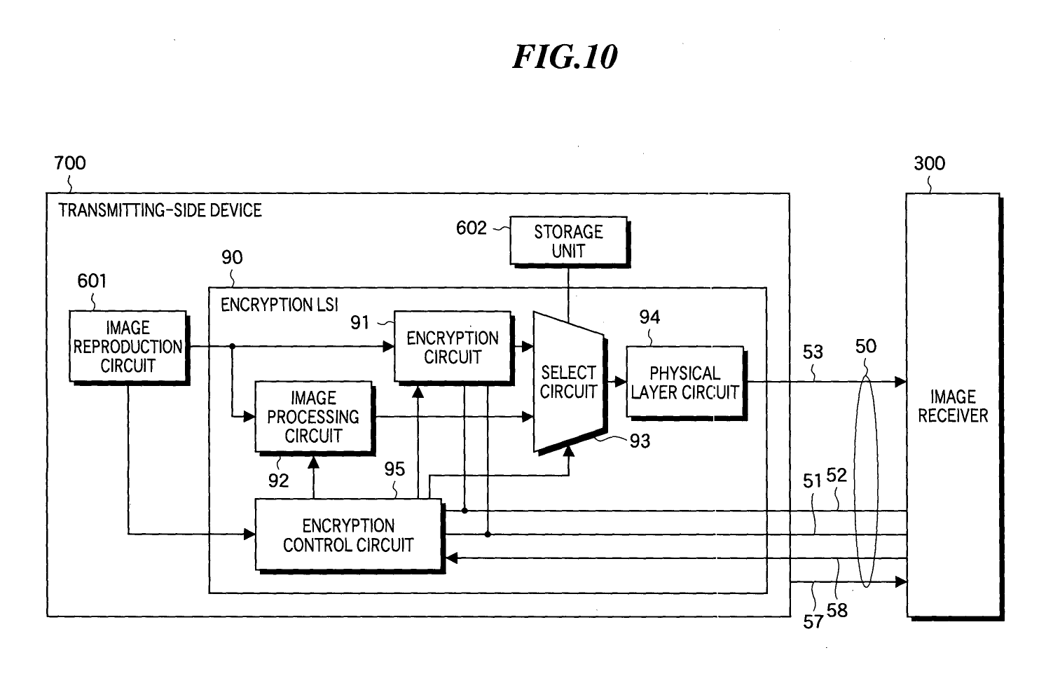

FIG. 10 is a block view showing an image transmission system employing the transmitting-side device relating to the second embodiment of the present invention. The receiving-side device is the same as the image receiver 300 as shown in FIG. 2.

An encryption LSI 90 included in the transmitting-side device 700 includes therein an encryption circuit 91 for encrypting an image signal output from the image reproduction circuit 601, an image processing circuit 92 for implementing predetermined signal processing on the image signal output from the image reproduction circuit 601, a select circuit 93 for selecting one of an image signal output from the encryption circuit 91 and an image signal output from the image processing circuit 92, a physical layer circuit 94 for transmitting the image signal selected by the select circuit 93 and an encryption control circuit 95.

The encryption control circuit 95 determines whether or not the image receiver 300 is authentic based on the received encryption key. When the image receiver 300 is authenticated, the select circuit 93 is controlled such that the image signal not subjected to the predetermined signal processing is encrypted and outputted. When the image receiver 300 is not authenticated, the select circuit 93 is controlled such that the image signal subjected to the predetermined processing is outputted without being encrypted.

The following is a detailed description of the operation of the receiving-side device according to this embodiment.

When it is determined that the image receiver 300 is compatible with the HDCP method, the encryption control circuit 95 controls the encryption circuit 91 and the HDCP decryption circuit of the image receiver 300 to start authentication of the image receiver in accordance with the HDCP method. When the image receiver is authenticated, the encryption control circuit 95 controls the encryption circuit 91 to start encryption of the image signal output from the image reproduction circuit 601 and controls the select circuit 93 to select an image signal output from the encryption circuit 91.

On the other hand, when authentication of the receiver is not finished within a predetermined time, the encryption control circuit 95 activates the image processing circuit 92 and controls the select circuit 93 to select an image signal output from the image processing circuit 92. In this way, when the receiving-side device is not authenticated, it is possible to display a low-resolution image that does not require protection or comments expressing that content cannot be transmitted on the screen of the image receiver 300.

In the above, a description is given based on the embodiments of the present invention but the present invention is by no means limited in this respect and may be freely modified and altered within the scope of the present invention as laid out in the patent claims.

Industrial Applicability

The present invention is capable of being utilized in a transmitting-side device such as a computer for encrypting and transmitting an image signal and a receiving-side device such as a monitor or a projector for receiving and decrypting the encrypted image signal.

1. (Amended) A semiconductor integrated circuit for use in a device for receiving an encrypted image signal in accordance with DDC (display data channel) standard, comprising:
a memory control circuit for controlling writing and/or reading of first information assigned to a receiving device according to the DDC standard and second information to be used in decrypting the encrypted image signal to/from a non-volatile memory; and
an interface circuit for controlling transmitting and receiving of the first and second information so as to perform serial communication with an external.

2. The semiconductor integrated circuit according to claim 1, wherein the first information includes EDID (extended display identification data) relating to said device.

3. The semiconductor integrated circuit according to claim 1, wherein the second information includes an encryption key to be used in decrypting the encrypted image signal.

4. The semiconductor integrated circuit according to claim 3, further comprising an encryption key decrypting circuit for decrypting the encryption key stored in an encryption manner in the non-volatile memory.

5. The semiconductor integrated circuit according to claim 4, further comprising an encryption key encrypting circuit for encrypting the encryption key provided from the external.

6. The semiconductor integrated circuit according to claim 5, wherein said encryption key encrypting circuit encrypts the encryption key with at least the same encryption strength as that of the encrypted image signal.

7. The semiconductor integrated circuit according to claim 5, wherein said encryption key encrypting circuit is activated when a predetermined command is inputted into the semiconductor integrated circuit.

8. The semiconductor integrated circuit according to claim 1, wherein said memory control circuit calculates an error detection code or error correction code to verify information written into the non-volatile memory in order to check whether or not the information is correctly written into the non-volatile memory.

9. The semiconductor integrated circuit according to claim 1, further comprising the non-volatile memory.

10. The semiconductor integrated circuit according to claim 1, further comprising a memory for temporarily storing content stored in the non-volatile memory.

11. The semiconductor integrated circuit according to claim 1, further comprising:
a receiving circuit for receiving the encrypted image signal; and
an image signal decrypting circuit for decrypting the encrypted image signal received by the receiving circuit by using the second information stored in the non-volatile memory.

12. The semiconductor integrated circuit according to claim 11, wherein said image signal decrypting circuit decrypts an image signal encrypted in accordance with a method conforming to HDCP (high bandwidth digital content protection).

13. (Canceled)

14. A semiconductor integrated circuit for use in a device for encrypting an image signal and transmitting the image signal to a receiving-side device, comprising:
an image processing circuit for subjecting the image signal to predetermined image processing;
a select circuit for selecting one of an image signal not subjected to the predetermined signal processing and an image signal subjected to the predetermined image processing;
an encryption circuit for encrypting the image signal selected by the select circuit; and
a control circuit for determining whether or not the receiving-side device is authentic on the basis of an encryption key received from the receiving-side device to control the select circuit and the encryption circuit such that the image signal not subjected to the predetermined signal processing is encrypted and output in the case where the receiving-side device is authenticated, and control the select circuit and the encryption circuit such that the image signal subjected to the predetermined processing is output without being encrypted in the case where the receiving-side device is not authenticated.

15. A semiconductor integrated circuit for use in a device for encrypting an image signal and transmitting the image signal to a receiving-side device, comprising:
an encryption circuit for encrypting an image signal;
an image processing circuit for subjecting an image signal to predetermined image processing;
a select circuit for selecting one of an encrypted image signal and an image signal subjected to the predetermined signal processing; and
a control circuit for determining whether or not the receiving-side device is authentic on the basis of an encryption key received from the receiving-side device to control the select circuit such that the image signal not subjected to the predetermined signal processing is encrypted and output in the case where the receiving-side device is authenticated, and control the select circuit such that the image signal subjected to the predetermined processing is output without being encrypted in the case where the receiving-side device is not authenticated.

16. (Amended) A device for receiving an encrypted image signal in accordance with DDC (display data channel) standard, comprising:
receiving means for receiving the encrypted image signal;
a non-volatile memory for storing first information assigned to a receiving device according to the DDC standard and second information to be used in decrypting the encrypted image signal received by the receiving means;
interface means for controlling transmitting and receiving of the first and second information so as to perform serial communication with an external; and
decrypting means for decrypting the encrypted image signal received by the receiving means by using the second information stored in the non-volatile memory.

17. The device according to claim 16, wherein said non-volatile memory stores EDID (extended display identification data) relating to said device, as the first information.

18. The device according to claim 16, wherein said non-volatile memory stores an encryption key to be used in decrypting the encrypted image signal, as the second information.

19. The device according to claim 18, wherein:
said non-volatile memory stores an encrypted encryption key as the second information, and
said device further comprises encryption key decrypting means for decrypting the encrypted encryption key stored in the non-volatile memory.

20. The device according to claim 19, further comprising:
an encryption key encrypting means for encrypting an encryption key provided from the external.

21. The device according to claim 16, wherein said non-volatile memory includes a serial EEPROM (electrically erasable programmable read-only memory).

22. The device according to claim 16, further comprising a microcomputer for controlling the non-volatile memory.

23. The device according to claim 16, further comprising a memory for temporarily storing content stored in the non-volatile memory.

24. (Amended) The device according to claim 16, wherein said decrypting means decrypts an image signal encrypted in accordance with a method conforming to HDCP (high bandwidth digital content protection).

25. (Canceled)

26. (Canceled)

27. (Canceled)

28. (Canceled)

29. (Canceled)

30. (Canceled)

31. (Canceled)

32. (Canceled)

33. (Canceled)
